(19) United States
(12) Patent Application Publication
(10) Pub. No.: US 2025/0297928 A1
(43) Pub. Date: Sep. 25, 2025

(54) Device for Measuring Multi-Gas Adsorption In Materials

(71) Applicant: Matrix Sensors Inc., San Diego, CA (US)

(72) Inventors: Thomas D. Carr, Encinitas, CA (US); Jessica Carey Moreton, San Diego, CA (US); Steven Yamamoto, San Diego, CA (US)

(21) Appl. No.: 19/084,425

(22) Filed: Mar. 19, 2025

Related U.S. Application Data
(60) Provisional application No. 63/567,363, filed on Mar. 19, 2024.

(51) Int. Cl. G01N 1/22; G01N 5/02

(52) U.S. Cl. CPC G01N 1/2202; G01N 5/025

(57) ABSTRACT

An uptake measurement system for determining analyte uptake in a material is described. The uptake measurement system includes a test chamber where an uptake sensor measures the uptake of one or more gases under testing conditions. The uptake sensor includes at least two transducers, each measuring distinct characteristics of the analyte as it is adsorbed or absorbed onto the material. Based on the measurements from both transducers and the testing conditions, the uptake of the gas by the material is calculated.

### CROSS REFERENCE TO RELATED APPLICATIONS

The present application claims a benefit, and priority to, U.S. Patent Application Ser. No. 63/567,363, filed Mar. 19, 2024, the contents of which is incorporated by reference in its entirety.

### FIELD OF DISCLOSURE

The present disclosure generally relates to a system for measuring the uptake of a material, and more specifically to measuring uptake of two or more chemicals in the gas stream independently.

### BACKGROUND

Recently, the concerns over greenhouse gas emissions have prompted numerous efforts for mitigation strategies. One such strategy involves carbon capture and sequestration technologies which seek to curtail the amount of carbon dioxide and other harmful gases released into the atmosphere. A promising approach for carbon capture is to use solid sorbent materials as a way to selectively remove carbon dioxide from combustion processes as well as directly from the atmosphere. For this approach to be cost-effective, solid sorbents must be engineered to meet certain performance requirements such as gas uptake, selectivity, uptake at various temperatures and humidities, and speed or rate at which gas is adsorbed and desorbed. To do this requires a means for quickly and accurately measuring the performance of sorbent materials.

Today, there are many commercially-available instruments capable of measuring adsorption properties of materials, including dynamic vapor sorption (DVS), thermogravimetric analysis (TGA), gravimetric or volumetric physisorption, and column breakthrough (CB). While these instruments have standardized the measurement of single-component gas adsorption, their ability to characterize mixed-gas adsorption is limited. Furthermore, these methods are inherently slow and tedious, which hampers the rate at which sorbents can be screened based on performance. Accordingly, there is a need for an improved device and method for measuring the adsorption or absorption of one or more gases in a sorbent material accurately and quickly to overcome the limitations of existing technologies.

### SUMMARY

Described herein are configurations that include systems and methods for determining an uptake of a material exposed to a gas in a gas mixture. For example, a method comprises generating a testing environment for an uptake sensor within a test chamber of an uptake measurement system, where the testing environment includes a gas mixture under a set of testing conditions and the uptake measurement system is configured to measure the uptake of a gas in the gas mixture using a first transducer and a second transducer. The configuration continues with measuring, using the first transducer, a first set of signals representing a first characteristic of the gas in the gas mixture adsorbing or absorbing onto a first thin film formed from the material and coupled to the first transducer. The configuration continues with measuring, using the second transducer, a second set of signals representing a second characteristic of the gas in the gas mixture adsorbing or absorbing onto a second thin film formed from the material and coupled to the second transducer and determining the uptake of the gas by the material based on the first set of signals representing the first characteristic and the set of testing conditions. The second set of signals represents the second characteristic.

In some embodiments, the gas mixture comprises carbon dioxide, nitrogen, and water vapor. In some embodiments, the first transducer is a gravimetric mass transducer and the first set of signals represents a total mass uptake of the material of the first thin film. In some embodiments, the second transducer is a capacitive transducer and the second set of signals represents a change in capacitance induced at least by adsorption or absorption of a polar component from the gas mixture onto the second thin film.

In some embodiments, the configuration continues with calibrating the second transducer by measuring an uptake of an amount of a component of interest in the gas mixture using the first transducer relative to a change in a characteristic induced by the uptake of the component of interest by the second transducer. In some embodiments, the second transducer is an optical transducer and the second set of signals represents a change in an optical characteristic induced by the gas in the gas mixture adsorbing onto the material of the second thin film.

In some embodiments, the set of testing conditions comprises: a concentration of the gas in the gas mixture, a relative humidity, a constant temperature, a constant pressure, and a constant humidity. In some embodiments, the configuration continues with varying at least one testing condition of the set of testing conditions and determining an additional characteristic of the material based on the variation of the at least one testing condition of the set of testing conditions and the variation of the at least one set of signals. The additional characteristic may be a diffusivity of the gas in the thin film.

In some embodiments, the configuration continues with varying at least one testing condition of the set of testing conditions and determining an additional characteristic of the material based on the variation of the at least one testing condition of the set of testing conditions and the variation of at least two sets of signals. The additional characteristic may be a diffusivity of the gas in the thin film.

### BRIEF DESCRIPTION OF DRAWINGS

The figures depict various embodiments for purposes of illustration only. One skilled in the art will readily recognize from the following discussion that alternative embodiments of the structures and methods illustrated herein may be employed without departing from the principles described herein.

FIG. 1 illustrates a high-level representation of an uptake measurement system, according to an example embodiment.

FIGS. 2A and 2B illustrate an example of a material that uptakes an analyte, according to some example embodiments.

FIG. 3 illustrates a device within an uptake measurement system, according to an example embodiment.

FIG. 4 illustrates an example of an analyte uptake calculation, according to an example embodiment.

FIG. 5 illustrates a comparison of uptake measurements by two uptake measurement systems, according to an example embodiment.

FIG. 6 is a box diagram of an uptake measurement system, according to an example embodiment.

FIG. 7 illustrates a first example uptake sensor, according to an example embodiment.

FIG. 8 illustrates a side view of a second example uptake sensor, according to an example embodiment.

FIG. 9 illustrates a side view of a third example uptake sensor, according to an example embodiment.

FIG. 10A shows a top view of a fourth uptake sensor, according to an example embodiment.

FIG. 10B is a cross-sectional view of an uptake sensor, according to an example embodiment.

FIG. 11 is a schematic block diagram of a readout electrically coupled to an uptake sensor, according to an example embodiment.

FIG. 12 is a schematic block diagram of a data processing flow for measuring uptake of a sensing material using an uptake measurement system, according to an example embodiment.

FIG. 13 illustrates a workflow for an uptake measurement of a sensing material, according to an example embodiment.

FIG. 14 is a block diagram illustrating components of an example machine for reading and executing instructions from a machine-readable medium, according to an example embodiment.

### DETAILED DESCRIPTION

### I. Introduction

The need for robustly-capable gas uptake methods and devices to measure adsorption and/or absorption of one or more analytes by a material is of growing importance in industrial applications, such as gas separations, gas storage, and carbon capture from both point sources and directly from the atmosphere to mitigate the effects of climate change. The practical implementation of adsorbents in an industrial process requires a quantitative understanding of the material's sorption properties under mixed-gas conditions. Without this detailed understanding, both the selection of a material and the design of a separation process can become slow and tedious and may rely on optimization through trial-and-error, which is often based on flawed extrapolations of simpler separations.

Despite growing need for the methods and devices described above, many of the current methods for measuring gas uptake are suboptimal. Current state-of-the-art procedures can be time-consuming and labor-intensive, requiring substantial investments in terms of both production and maintenance. Additionally, they often lack in accuracy, a key attribute considering the potential implications of erroneous readings. In industries where precision and reliability are crucial, these methods fall short, thereby calling for improved alternatives.

The implementation of a more efficient, cost-effective, and accurate uptake methods and devices could dramatically impact and enhance multiple technological sectors. Such an evolution would not only alleviate current difficulties but could also open doors to novel applications and advancements. Accordingly, a device and/or process able to accurately measure the uptake for single or multiple analytes via a thin film of the sorbent material on various transducers (e.g. gravimetric and capacitive) would be beneficial. Devices capable of accomplishing this may transform the way data is collected and applied across various fields, offering a more dependable and economical alternative to the existing, less efficient methods.

To address this need, an uptake measurement system is described herein. The uptake measurement system measures the uptake of one or more analytes by a material. (The one or more analytes may be hereinafter referred to in the singular “analyte” although it is understood that multiple analytes are possible.) As an example, the one or more analytes may include a gas such as, e.g., CO₂, a vapor such as, e.g., H₂O vapor, a chemical such as formaldehyde, etc. The material may be a proprietary material designed to absorb a specific analyte, CO₂, for carbon capture technologies, e.g., “a capture material.” Depending on the configuration, the uptake measurement system may measure the absorption or adsorption of the material. Thus, given this nomenclature, the uptake measurement system measures the adsorption or absorption of carbon dioxide by the capture material.

At a high level, to measure the uptake of one or more analytes by the material (hereinafter “analyte uptake”), the uptake measurement system includes at least two sensing devices. In an example configuration, the two sensing devices may be a first transducer and a second transducer, but other configurations are possible. The two sensing devices are exposed to a testing environment, and the testing environment is configurable to include one or more analytes under various testing conditions. For example, the testing environment may be a test chamber, and, in this case, the uptake measurement system may establish the testing conditions by introducing a carrier gas including the analyte to the test chamber.

When exposed to the testing conditions in the testing environment, the first device measures a first characteristic of the material as the material adsorbs or absorbs a first analyte, and the second device measures a second characteristic of the material as the material adsorbs or absorbs a second analyte. In an example, the first device may be a gravimetric transducer that measures mass uptake, and the second device may be a capacitive transducer that measures an electrical capacitance and/or a change in electrical capacitance. As described in greater detail below, the uptake measurement system measures signals representing the characteristics measured by the devices and converts those signals into the analyte uptake.

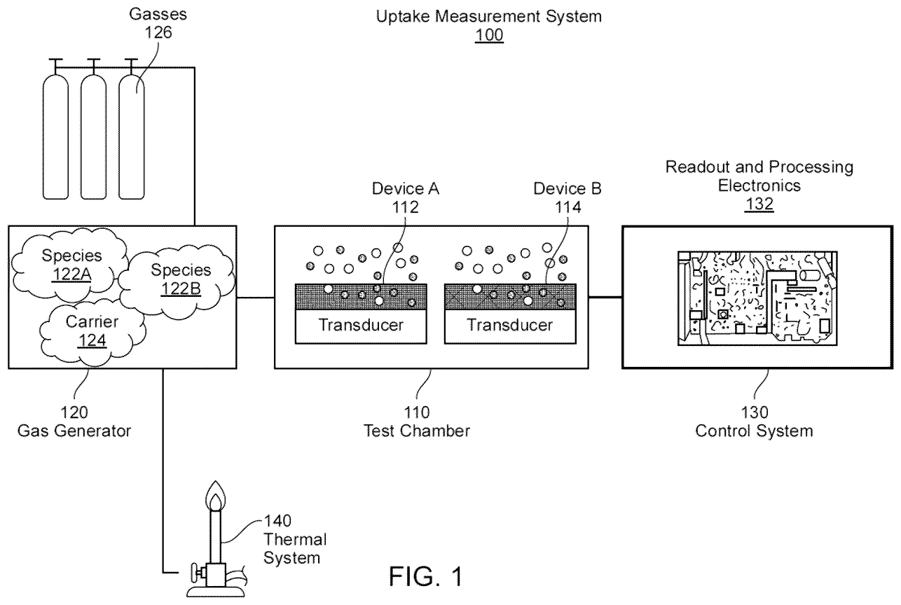

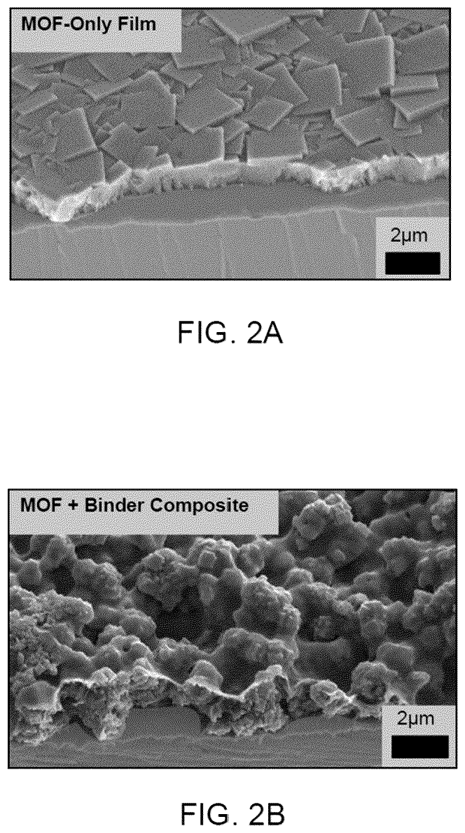

To illustrate, FIG. 1 illustrates a high-level representation of the uptake measurement system, according to an example embodiment. As illustrated, the uptake measurement system 100 includes a test chamber 110 including two devices (e.g., Device A 112 and Device B 114). The devices include the material that adsorbs or absorbs one or more analytes. See, e.g., FIGS. 2A and 2B.

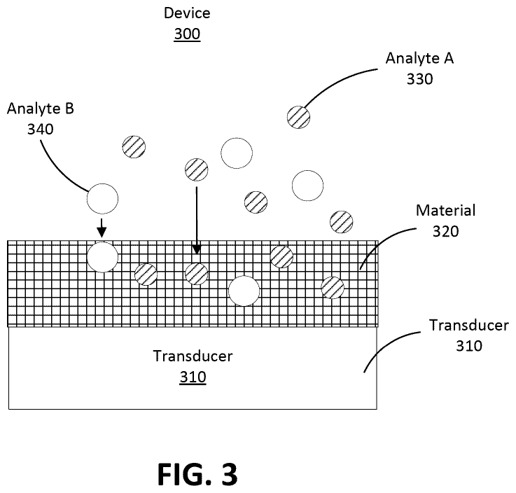

The uptake measurement system 100 establishes a testing environment having testing conditions within the test chamber 110. To do so, in the illustrated example, the uptake measurement system 100 employs a gas generator 120 to generate a gas mixture (e.g., including, at least, a first species 122A, a second species 122B, and a carrier gas 124) from gasses 126. The uptake measurement system 100 may also include a thermal system 140 to control the temperature of test devices and gasses in the test chamber 110. As the devices in the test chamber 110 are exposed to the carrier gas including the species, the material adsorbs or absorbs those species. See, e.g., FIG. 3.

Different gas mixtures are possible. For example, in the illustrated gas mixture, the first species 122A may be a first analyte CO₂, the second species 122B may be a second analyte H₂O vapor, and the carrier gas 124 may be N₂. The carrier gas may also be Helium, Argon, synthetic air, or a mixture of individual carrier gases.

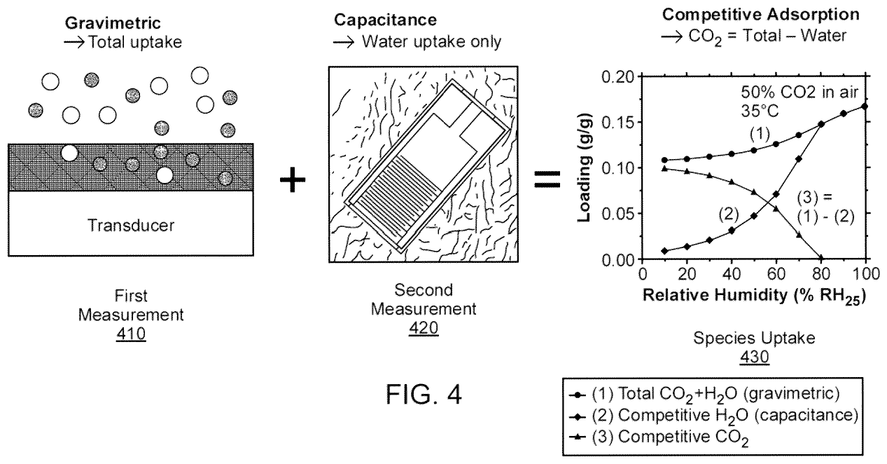

The devices generate signals representing measured characteristics of the material as it absorbs or adsorbs the analyte. The uptake measurement system includes a control system 130 to measure the analyte uptake. To do so, the control system includes signal readout and processing electronics 132 configured for measuring the various signals generated by the transducer(s) and converting the measured signals into a measurement of analyte uptake. See, e.g., FIG. 4.

FIG. 2A and 2B illustrate an example of a material that uptakes an analyte, according to some example embodiments. In FIGS. 2A and 2B the material is formed as a thin film. In FIG. 2A, the thin film is a metal organic framework (“MOF”), and in FIG. 2B the thin film is a MOF powder with a binding agent. Other thin films are also possible.

FIG. 3 illustrates a device within the uptake measurement system, according to an example embodiment. In this example, the device 300 includes a transducer 310 and a material 320. The material is a thin film coupled to (or disposed on) the transducer 310. The device is in a testing environment and exposed to testing conditions. As shown, the testing environment includes an Analyte A 330 (e.g., an interferent gas such as water), an Analyte B 340 (e.g., a gaseous analyte), and a carrier gas (not shown, for clarity). As the material 320 uptakes (e.g., absorbs or adsorbs) the analytes, the transducer generates signals (not shown) representing that uptake.

FIG. 4 illustrates an example of an analyte uptake calculation, according to an example embodiment. In this example, Analyte 1 is CO₂ and Analyte 2 is water vapor. Using the context of FIG. 1, the first device is a gravimetric transducer with a thin film of the material that measures the uptake of both the analytes (e.g., first device measurement 410). The second device is a capacitive transducer with a thin film of the material that measures the uptake of only Analyte 2 (e.g., second device measurement 420). The uptake measurement system 100 then generates a measurement of the Analyte 1 uptake 430 using measurements from the first device and the second device. As shown, the measurement of the Analyte 1 uptake is the total uptake measured from the first transducer less the uptake of the interferant gas (Analyte 2) measured from the second transducer.

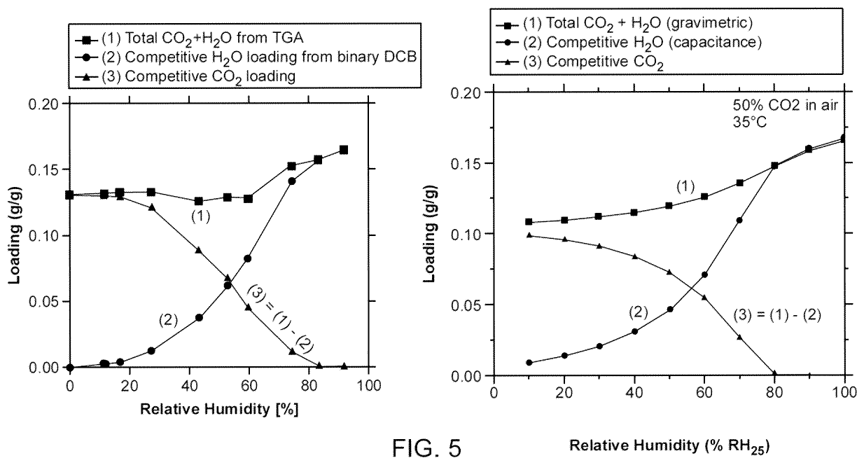

FIG. 5 illustrates a comparison of uptake measurements by two uptake measurement systems, according to an example embodiment. The left panel of FIG. 5 shows the uptake of carbon dioxide by a sequestration material using a first uptake measurement system, and the right panel of FIG. 5 shows the uptake of carbon dioxide by that same sequestration material using a second uptake measurement system. See Lin, J.-B.; Nguyen, T. T. T.; Vaidhyanathan, R.; Burner, J.; Taylor, J. M.; Durekova, H.; Akhtar, F.; Mah, R. K.; Ghaffari-Nik, O.; Marx, S.; Fylstra, N.; Iremonger, S. S.; Dawson, K. W.; Sarkar, P.; Hovington, P.; Rajendran, A.; Woo, T. K.; Shimizu, G. K. H. A Scalable Metal-Organic Framework as a Durable Physisorbent for Carbon Dioxide Capture. Science 2021, 374 (6574), 1464-1469. The first uptake measurement system is known in the art, and the second uptake measurement system is configured as described herein. Notably, the uptake curves in both the first and second uptake measurement systems are largely the same. However, the measurement process for the first uptake measurement system took several months, while the measurement process for the second uptake measurement system took a few days.

### II. Example Uptake Measurement System

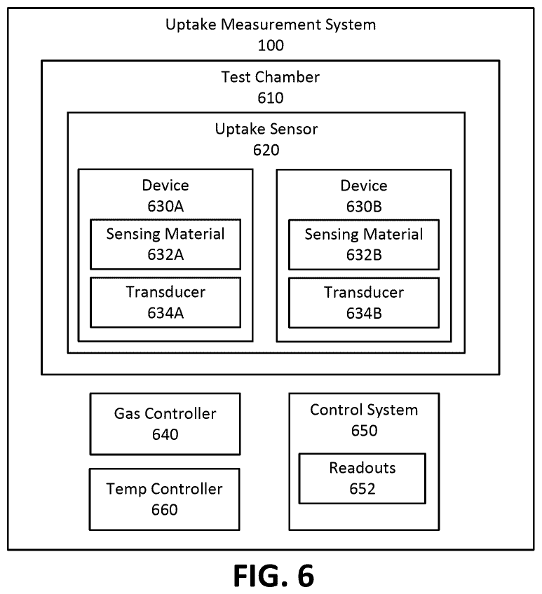

The specification now turns to a more in-depth discussion of the components and methods of the disclosed uptake measurement system. FIG. 6 is a box diagram of the uptake measurement system, according to an example embodiment. As shown, the uptake measurement system 100 includes a test chamber 610, a gas controller 640, a temperature controller 660, a control system 650 (as discussed in FIG. 1), and readouts 652. The test chamber includes an uptake sensor 620, and the uptake sensor includes a first device 630A and a second device 630B. Each device includes a sensing material (e.g., first sensing material 632A and second sensing material 632B) and a transducer (e.g., first transducer 634A and second transducer 634B). Depending on the configuration, the first sensing material 632A and the second sensing material 632B may be the same material or piece of material, or the sensing materials 632A, 632B may be a different material or piece of material.

The uptake measurement system 100 may include additional or fewer components, or those components may be arranged and connected in a manner different than those disclosed herein. For example, in some example configurations, the uptake measurement system 110 may include one or more additional test chambers 610 and each of those additional test chambers 610 may include an additional sensor 620 (with each additional sensor including a first device 630A and a second device 630B), or each test chamber 610 may include one or more additional sensor(s) 620. Moreover, the functionality of one or more of the elements of the uptake measurement system 100 may be attributable to other elements of the uptake measurement system 100 or a different system altogether. For instance, in some configurations, the gas controller 640 or the control system 650 may be coupled (e.g., gaseously, communicatively, etc.) to the uptake measurement system 100, and/or one or more functions of the control system may be attributable to the gas controller 640.

### Operation

The uptake measurement system 100 includes a test chamber 610. The test chamber 610 is an enclosed space within the uptake measurement system 100 where an uptake sensor 620 measuring the uptake for a material is exposed to one or more analytes, and the uptake of those one or more analytes for the material is measured. The test chamber 610 is gaseously coupled to the gas controller 640, and electronically coupled to the control system 650. The gas controller 640 and the control system 650 are configured to establish testing conditions within the test chamber. The testing conditions include, e.g., pressure, temperature, humidity, amount and color of light, etc.

Within the test chamber 610 is an uptake sensor 620. The uptake sensor 620 generates signals that, when processed by the control system 650, generate a measurement of the uptake of an analyte by a material. Each uptake sensor 620 includes one or more devices 630. Each device 630 measures one or more characteristics of a material (e.g., sensing material 632) as the material uptakes an analyte in the gas stream from the gas controller 640 and generates a signal representing that characteristic.

Typically, each device 630 includes a sensing material 632 and a transducer 634. The sensing material 632 is made from the material and is disposed on the transducer 634. Thus, when the sensing material 632 uptakes the analyte, the characteristics of the sensing material 632 change. The transducer 634 coupled to the sensing material 632 measures the characteristics (or changes in the characteristics) of the sensing material 632 and generates signals representing those characteristics. The control system 650 receives those signals and determines properties of the sensing material 632 based on those signals. Sensing materials 632 and transducers 634 are described in greater detail below.

The uptake measurement system 100 includes a gas controller 640. The gas controller 640 controls gasses flowing into and out of the test chamber 610. To do so, the gas controller 640 may include various modules to manage the interaction between the analyte gas, the carrier gas, and the measured material (e.g., sensing material 632). For instance, the gas controller 640 includes an inlet and outlet setup for directing gas flow into and out of the test chamber 610. The inlet control allows the regulated introduction of the analyte and/or carrier gas into the test chamber 610. The outlet, conversely, facilitates the expulsion of gases from the test chamber 610 post interaction with the thin film mounted on the transducers.

The gas controller 640 may include a local controller or may be controlled by the control system 650. The controller monitors and regulates the release of both the analyte and the carrier gas. The controller is adjustable, enabling precise control over the volume, concentration, and flow rate of the gases entering the chamber, thereby enabling manipulation of the testing conditions internal to the test chamber 610. Finally, the gas controller 640 may include valves at the entry and exit points of the test chamber 610. These valves are designed to open and close to enable reaching and maintaining the test conditions.

The uptake measurement system includes a temperature controller 660. The temperature controller 660 controls the temperature of the test chamber, which in turn sets the temperature of the uptake sensor. The test chamber can be configured in many ways. For example, in some embodiments, the test chamber is an oven or environmental chamber, and the uptake sensor(s) are placed in the test chamber and the air inside is controlled to the desired test temperature. For tests where temperature of the uptake sensor must change rapidly, the test chamber may be a plate made from a thermally conductive material, such as aluminum or magnesium. The uptake sensor(s) may take the form of a solid block of thermally conductive material in which cavities have been formed to receive the devices and passages formed for flow of the analyte and carrier gasses over the devices. The uptake sensor(s) may be attached to the test chamber to maximize heat flow. Furthermore, the temperature of the test chamber may be controlled by thermo-electric elements, fluids, or other means that provide rapid temperature change.

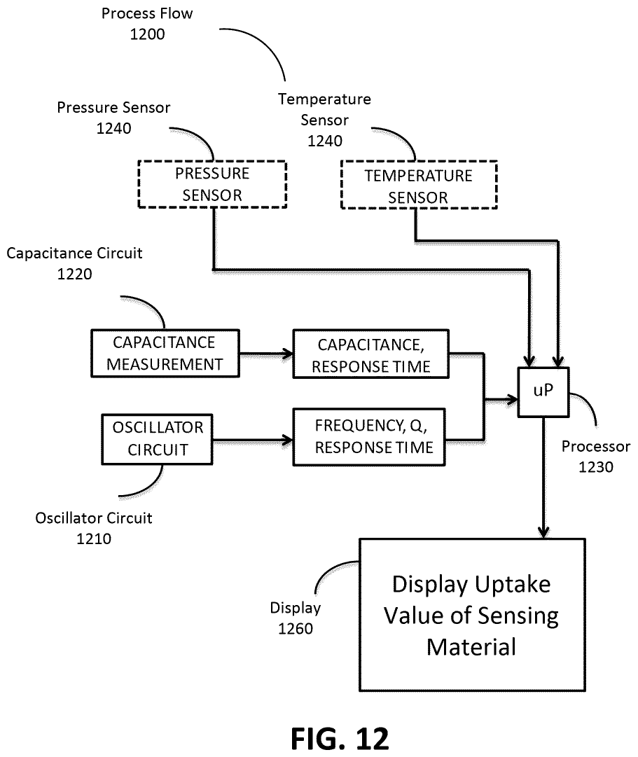

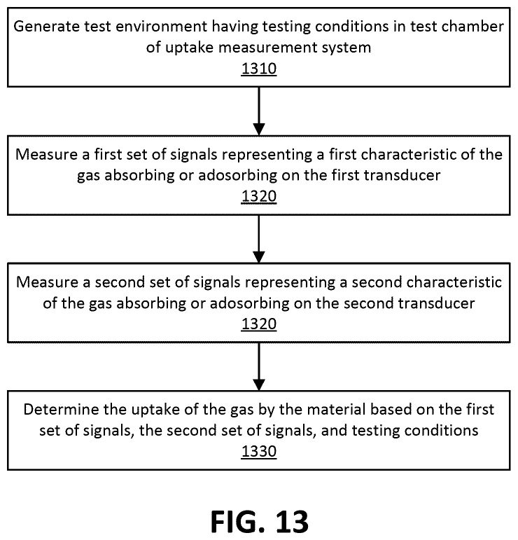

The control system 650 is configured to determine the uptake of a sensing material 632 using the uptake sensor 620. To do so, the control system 650 may include one or more readouts 652 which are electrically coupled to any of the devices 630, sensing materials 632, and transducers 634. The readouts 652 take measurements of various characteristics of the sensing material 632 and transducer 634 and generate a measurement of the uptake of the sensing material 632. As an example, the first device 630A may be a mechanical resonator configured to measure the response of first sensing material 632A using a first transducer 634A, and the second device 630B may be a capacitor configured to measure the capacitance of the second sensing material 632B using a second transducer 634B. The first sensing material 632A and the second sensing material 632B may be the same or different sensing materials 632. The control system 650 employs one or more readouts 652 to measure the responses to determine the characteristics of the sensing material 632 (see, e.g., FIGS. 12 and 13).

Additionally, the control system 650 may be employed to control a test of an uptake sensor 620 in the test chamber 610. To do so, the control system 650 may cause the gas controller 640 (and other components of the uptake measurement system 100) to establish a testing environment in the test chamber 610. The testing environment may include a set of testing conditions such as, e.g., the temperature, pressure, humidity, and gas mixture (including the makeup of the gas mixture).

Moreover, the control system 650 may enable a time series of measurements to be performed by the uptake measurement system 100. In this case, the control system 650 may vary or keep constant one or more of the conditions of the testing conditions. For example, the control system 650 may vary the temperature in the test chamber 610 over time, may vary the humidity in the test chamber 610 over time, or may keep the testing conditions constant over time. In these situations, the control system 650 may use the variation of the testing conditions to determine a measure of the uptake of the sensing material 632. For example, the control system 650 may use the change of temperature in the test chamber 610 when determining a measure of uptake by the sensing material 632. Additionally, the time series of measurements and/or changing testing conditions in the test chamber 610 may enable the control system 650 to take different uptake measurements of the sensing material 632 such as, e.g., diffusivity, and determine an additional characteristic of sensing material 632 based on the variation of at least one testing condition and variation of one or more sets of signals.

To provide an example, the control system 650 may step the gas of interest from low to high concentrations (400 ppm to 2,000 ppm, e.g.) in the absence of water at a fixed temperature (25° C., e.g.), or may step humidity from low to high (10% relative humidity to 90% relative humidity, e.g.) in the absence of the gas of interest at a fixed temperature (25° C., e.g.). Additionally or alternatively, the control system 650 may fix the concentration of the gas of interest at a specific level (400 ppm, e.g.) and step the humidity from low to high and back down to low all at a fixed temperature, or may fix the relative humidity at a specific level (50% relative humidity, e.g.) and step the CO₂ from low to high and back down to low at a fixed temperature.

The control system 650 may also leverage time-based measurements to measure the one or more kinetic characteristics of sensing material uptake. Generally, kinetic characteristics are those measurements and properties that describe the speed at which a sensing material 632 uptakes an analyte. To measure kinetic properties, conventional systems often introduce a step change in one of the test environmental conditions. Change in the uptake over time can be fitted to a model, and a time constant can be derived. However, this method is unreliable when two analytes are present that have either similar time constants or widely separated time constants. For example, conventional systems may measure the time constant using a quasi-equilibrium method whereby the concentrations of the analytes are held constant and either temperature or pressure at the uptake sensor are varied in such a way that a frequency response relating the stimulus (e.g., temperature or pressure) to the response (e.g., uptake) over frequency can be derived. The inverses of the time constants show up as maxima in the imaginary part of the frequency response. This works poorly when the time constants of the analytes are similar. The system described herein does not have this downside. Instead, the system described herein allows for the measurement of one of time constants using a device that is sensitive to only one of the analytes and removing the time constant from the data recorded from a device that is sensitive to both. In this way, the time constants for kinetics of mixed analytes can be derived using only single component models.

The control system 650 may also calibrate one or more transducer 634. To do so, as an example, the control system 650 may measure capacitance vs. water uptake (using a first transducer 634) to get a calibration curve of water uptake vs. capacitance (for the second transducer 634). Moreover, there may be cross-talk between the devices. For example, the capacitor may respond to CO₂ loading. The control system may also calibrate and compensate the transducer despite the crosstalk.

Additionally, the control system 650 may enable the uptake measurement system 100 to perform parallel uptake measurements of one or more uptake sensors 620. In this case, there may be one or more test chambers 610, and each test chamber may have one or more uptake sensors 620. The control system 650 may control the testing conditions in each test chamber 610 and the testing conditions may be the same or different depending on the configuration of the test for the uptake sensor(s) 620. In this case, the control system 650 may perform the same test on each uptake sensor 620 or may perform different tests on each uptake sensor 620. Whatever the case, the control system 650 may be configured to use the different tests to calculate the uptake of a sensing material 632.

### Sensing Materials

As described above, each device 630 of the uptake sensor 620 includes a sensing material 632. The sensing material 632 is configured to capture (e.g., sorb, adsorb, desorb, etc.)

an analyte (or analytes) such as a gas (e.g., carbon dioxide) if the analyte is present in the environment of the sensing material 632. The degree of gas capture is based on a temperature of the sensing material 632 and an amount of the gas (or analyte(s)) in the environment. For example, at lower temperatures the sensing material 632 captures more gas (e.g., via increased absorption), and captures less gas at higher temperatures (e.g., via decreased absorption). Similarly, for example, the sensing material 632 captures more gas at higher concentrations of gas in the environment, and at less gas at lower concentrations of gas in the environment. The sensing material 632 may also capture analytes in other substances such as, e.g., liquids.

More plainly, a sensing material 632 within an uptake measurement system 100 is configured to capture various analytes. So, for instance, if the analyte(s) are CO₂ and H₂O vapor, the sensing material 632 may be any material that can capture those analytes. Similarly, if the analyte is CH₄, the sensing material 632 may be any material that can capture that analyte. Some non-limiting examples of sensing materials for CO₂ and H₂O vapor are described below, but others are also possible.

The sensing material 632 may be a porous crystalline material such as a metal-organic framework (MOF), porous coordination polymer, porous coordination framework, zeolite, or supported amine material. Suitable porous sensing materials also include a covalent organic framework (COF) in which the framework includes covalent chemical bonds, rather than metal coordination bonds, and a zeolite, which is an inorganic porous crystalline material. In some embodiments, the porous sensing materials comprise non-crystalline porous materials such as metal-organic polyhedra having discreet porous cages, porous metal-organic polymer, metal-organic gel, or porous carbon (also known as activated carbon). Supported amines are a class of carbon capture material consisting of an aminated capture substance supported upon a porous framework which could be any of the classes above or other classes.

Metal-organic frameworks (MOFs) are an expanding class of porous crystalline materials that are built up from nodes of metal ions connected by organic linkers. These materials can typically be engineered to have pore apertures with a width or diameter in a range of less than 1 Angstrom to about 30 Angstroms, but could be other widths or diameters. A class of exotic MOFs (“MOF-74”) with pore aperture diameters of 98 Angstroms have also been demonstrated. MOFs with varying pore sizes can selectively adsorb molecules based on the size of the molecules. For example, engineered MOFs with pore sizes designed for carbon dioxide (CO₂) adsorption can separate gases in industrial processes. MOFs can also be used as sensing materials with a quartz crystal microbalance (QCM) to act as a chemical sensor in controlled environments. When one or more types of MOFs is used as a sensing material on a resonant sensor (e.g., transducer 634), the surface on which the MOF is grown may be prepared for MOF growth with a self-assembled monolayer (SAM) or by deposition of either an oxide or metal surface. The MOF coating on the oscillating portion of the sensor typically has a thickness in the range of 1 to 10,000 nm, but could be other thicknesses. MOFs can be designed with different pore sizes and specific chemical affinities to target specific gases with high selectivity.

In other embodiments, the sensing material 632 is a polymer film. The polymer sensing material is selected to fit the mechanical properties of the resonator (elasticity, density, thickness, etc.), so that detection time is reduced or minimized and sensitivity is increased or maximized. Sensors may be coated or functionalized with various types of sensing materials for specific applications. These possible sensing materials include, for example, porous receptor materials as listed above, polymers (co-polymers, bio-polymers), sol gels, and DNA, RNA, proteins, cells, bacteria, carbon nanotube arrays, catalysts including metals to enzymes, nanoclusters, organic and inorganic materials including: supramolecules, metal-organic complexes, or dendritic materials.

In some embodiments, the sensing material 632 is from a family of porous metal-organic framework materials known as amine-appended M₂(DOBPDC). Such materials exhibit characteristic gas uptake behavior that varies with temperature and the concentration of the target gas (e.g., CO₂). In particular, the material mmen-Mg2(DOBPDC) exhibits an impressive 14 weight percent CO₂ uptake that depends on temperature and the concentration of CO₂.

In some embodiment, the sensing material 632 may first be synthesized as a powder, then combined with a binder (often a polymer) to form an ink. Alternatively, the powder may be combined with a solvent, such as alcohol, to form a binder-less liquid suspension. The ink or the suspension is then deposited onto one or more transducers (e.g., a QCM and inter-digitated electrode [IDE] capacitor) through various means (e.g., spin coating, spray coating, drop casting). The sensing material and each transducer form a device 630, and the device(s) are two samples are mounted in the test chamber.

As described briefly above, the sensing material 632 can be configured to detect a variety of different analytes from different phases of matter. For example, the sensing material 632 can be configured to absorb: gases such as carbon dioxide, carbon monoxide, methane, hydrogen, volatile organic compounds, toxic gases, chemical warfare agents, greenhouse gases, combustibles, and refrigerants; and liquids such as glucose and aqueous lead. Correspondingly, the sensor device can be configured to detect the various analytes using the methods described herein.

### Transducers

As described above, each device 630 of the uptake sensor 620 includes a transducer 634. The transducer 634 is configured to sense a measure (e.g., of a characteristic) of the gas captured by the sensing material 632 and generate one or more measurement signals representing the measure of the captured gas. As described in greater detail below, the transducer 634 may include or utilize various additional elements of the uptake measurement system 100 to generate measurement signals.

In an example embodiment, the transducer 634 is a mass transducer. For example, the transducer 634 may be a resonant mass transducer such as a quartz crystal microbalance (QCM). The transducer 634 may be other types of transducers such as a capacitor (chemicapacitor), a resistor (chemiresistor), a gravimetric transducer, an optical transducer or the like. Some particular example mass transducers may include a Micro-Electro-Mechanical Systems (MEMS) transducer, a calorimeter, a surface acoustic wave (SAW) device, a bulk acoustic wave (BAW) transducer, a cantilever, and a capacitive micromachined ultrasonic transducer (CMUT).

Given the variability of transducers that may be employed by the uptake measurement system 100, the various measurement signals created by those transducers are also manifold. Typically, the measurement signal corresponds to the type of transducer employed. For instance, a chemicapacitor's measurement signal may reflect a capacitance measurement of the sensing material, a chemiresistor measurement signal may reflect a resistance measurement of the sensing material, and a mass transducer may reflect a mass measurement of the sensing material, but other examples are possible. Generally, the transducer generates a measurement signal by measuring an appropriate change in the transducer characteristics such as frequency, quality factor, stiffness, strain, optical characteristics, etc. Whatever the case, the transducer 634 measures a characteristic of the captured gas by generating a measurement signal representing that characteristic.

To continue, the transducer 634 is coupled to the sensing material 632 such that the transducer 634 is able to sense captured gas and create a measurement signal. Again, depending on the type of transducer, the transducer may be coupled to the sensing material 632 in a variety of ways. For instance, the sensing material 632 may be physically coupled or disposed (e.g., coated) for a mass transducer, optically coupled for an optical transducer, or electromagnetically coupled for, e.g., a chemicapacitor or chemiresistor.

Additionally, as described above, the transducer 634 may include or may be coupled to various elements of the uptake measurement system 100 to generate measurement signals. For example, the uptake measurement system 100 may also include at least one detector (e.g., a readout circuit for a resonant mass transducer) arranged to detect responses of the transducer 634 when substances (e.g., molecules of the analyte and/or water molecules) are adsorbed or absorbed in the sensing material 632. As an example, in an embodiment, the transducer 634 is a resonant mass transducer (e.g., a QCM), the transducer responds to mass changes in the sensing material 632 and generates signals representing that mass change. Detection electronics of the control system 650 measure the signals to determine the mass change. Additionally, in various example configurations, different systems may be used to generate a measurement signal and may be included in the uptake measurement system 100.

Finally, in many of the embodiments described herein, a QCM has been described as the transducer 634, and mass uptake signals of the QCM are the “transducer measurement signals.” However, there are many other suitable transducers, detection mechanisms for those transducers, and transducer measurement signals output from those detectors that may be employed. Transducer responses that may be detected and output as transducer measurement signals include a change in frequency, resonance frequency, dissipation, quality factor, temperature, stiffness, or strain, etc. The responses of the resonant transducer to mass loading in the sensing material 632 are often detected using an electrical property, such as a change in impedance of the circuit driving an oscillating motion of the transducer 634 (e.g., a phase-locked loop determines phase of the impedance).

### Example Sensors

As described above, each uptake sensor 620 of the uptake measurement system 100 includes one or more devices 630, and each device 630 includes a sensing material sensing material 632 and transducer 634. There can be many example configurations for devices 630 of the uptake measurement system 100, some of which are described hereinbelow.

### First Example Device

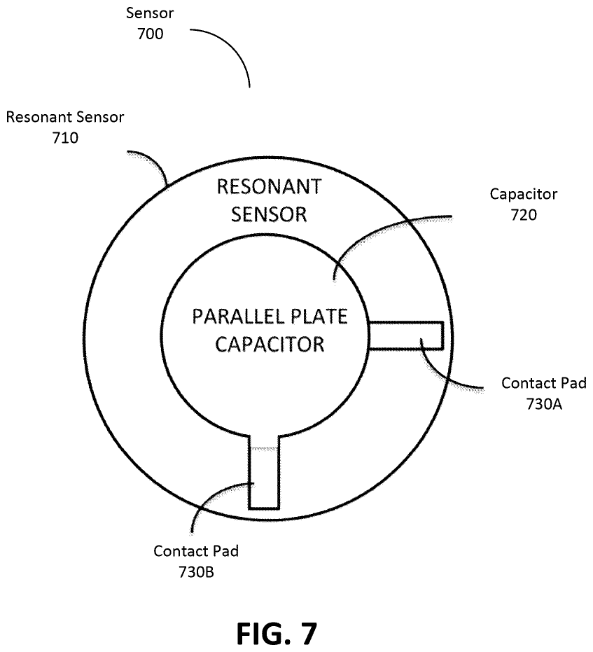

FIG. 7 illustrates a first example uptake sensor, according to an example embodiment. The uptake sensor 700 (e.g., an uptake sensor 620) includes a first transducer and a second transducer (e.g., transducer 634A, 634B).

The first transducer is a resonant sensor 710 and the second transducer is a parallel-plate capacitor 720. The capacitor 720 is positioned on the oscillating portion of the resonant sensor 710. The resonant sensor 710 is preferably a quartz crystal microbalance (QCM) but could be a different resonant sensor. As illustrated, the quartz crystal has a circular surface, and the parallel-plate capacitor 720 is positioned on the oscillating portion of the QCM substantially at the center of the circular surface. Other shapes are also possible. The capacitor 720 is formed by two electrodes having respective electrical contact pads 730A and 730B. The sensing material 632 is a thin film “sandwiched” between the electrodes of the parallel place capacitor 720. The top electrode of the parallel plate capacitor may be porous, meaning that the analyte may pass through the electrode and into the sensing material 632.

The resonant sensor 710 provides a gravimetric measurement that the uptake measurement system 100 may use to determine a measure (e.g., an amount) of a first analyte and/or a second analyte adsorbed or absorbed in the sensing material (e.g., sensing material 632, not shown). Depending on the configuration of the resonant sensor 710 the measurement may be of the mechanical or electromechanical response of the resonant sensor 710, such as a frequency shift or a change in resonance frequency, dissipation, quality factor, stiffness, or strain.

The capacitor 720 provides a capacitance measurement that the uptake measurement system 100 may use to determine a measure (e.g., an amount) of a second analyte (e.g., water vapor) that is adsorbed or absorbed in the sensing material (e.g., sensing material 632, not shown) on the resonant sensor 710. The capacitor 720 may measure the change in the dielectric of the sensing material. Changes in the dielectric are dominated by the presence of water in the sensing material since water is a highly polar molecule while carbon dioxide has extremely low (but not zero) polarity. Thus, to an excellent approximation, the signal from the capacitor is a measure of the amount of water present in the material.

The uptake measurement system 100 determines the uptake of the sensing material using the capacitance measurement combined with the resonator measurement. This combination of electromechanical and capacitance measurements enables the uptake measurement system 100 to distinguish between various types of adsorbed or absorbed molecules, especially distinguishing between an analyte of interest (e.g., carbon dioxide or methane) and water molecules that might interfere with the detection of the analyte. The capacitance measurement is used to determine how much of the response of the resonator 710 is due to water, and thus how much of the response of the resonator 710 is due to a mass of a first analyte (e.g., CO₂) in the sensing material.

### Second Example Device

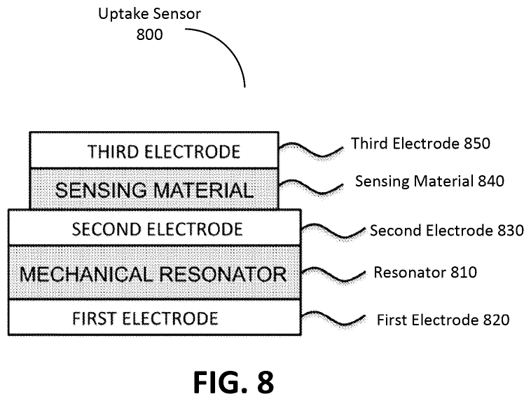

FIG. 8 illustrates a side view of a second example uptake sensor, according to an example embodiment. In some embodiments, the second example uptake sensor is the same as the first example uptake sensor described in relation to FIG. 7. The uptake sensor 800 (e.g., an uptake sensor 620) includes a first transducer and a second transducer (e.g., transducer 634A, 634B). The first transducer is a resonant sensor, and the second transducer is a parallel plate capacitor.

The resonant sensor includes a mechanical resonator 810 (e.g., a quartz crystal), a first (back) electrode 820 coupled to a back side of the resonator 810, and a second (front) electrode 830 that is coupled to a front side of the resonator 810. The first and second electrodes 820 and 830 are positioned to apply a potential difference across the resonator 810 to drive an oscillating motion of the resonator 810. The first and second electrodes 820 and 830 are typically gold, but could be another material. A sensing material 840 is disposed on the second electrode 830. The sensing material 840 at least partially covers the second (front) electrode 830. In some embodiments, the sensing material 840 covers the electrode 830 completely, although complete coverage is not necessary. In many configurations, the layer of the sensing material 840 on the second electrode 830 is sufficient to adsorb enough analyte (if present in the environment or sample to which the resonant sensor is exposed) to change the oscillation of the resonant sensor due to the mass of the analyte adsorbed. The sensing material 840 is preferably an adsorbing film (e.g., a metal-organic framework or a polymer film) that is grown or deposited directly on the front electrode 830.

The parallel-plate capacitor is formed by the second electrode 830 and a third electrode 850 disposed on the sensing material 840. If the resonator 810 is a QCM, the first electrode 820 is the back electrode, and the second electrode 830 is the front electrode. In an example configuration, the second (front) electrode 830 is grounded, and the capacitor shares the grounded second electrode 830 with the resonator 810. In an example configuration, the third electrode 850 is deposited or grown on top of the sensing material 840. The third electrode 850 may be gas-permeable (e.g. porous, slotted, interdigitated, or serpentine), and the permeability allows the sensing material 840 to sense (e.g., absorb or adsorb) to analyte molecules in a sample or in the environment to which the sensor 800 is exposed.

The second and third electrodes 830 and 850 preferably comprise substantially parallel layers or plates of metal, and a layer of the sensing material 840 is positioned between the parallel layers or plates of metal. The electrodes forming the parallel plates of metal typically include respective electrical contact pads (not shown). The third electrode 850 is typically gas-permeable (e.g., there are holes or openings in the electrode to permit molecules to pass through to the sensing material 840). As such, it is generally not necessary for the entire portion of each electrode to be a parallel plate that is fully intact, since the contact pad, holes, or other parts of each electrode may not exactly resemble a parallel plate. Instead, each of the electrodes 830 and 850 may have a major portion that is at least one layer of metal (that may include holes to be gas-permeable) that lies in a plane substantially parallel to the plane of the other electrode. Each electrode may include some other parts (e.g., electrical contact pads) that are not necessarily part of the parallel layer of metal. The contact pads preferably extend outwardly from the major portions of the electrodes to the edges or the non-oscillating portion of the quartz crystal. At that point, the contact pads connect to the holder of the quartz and in turn into vias or larger pads, as is known in the art. It is understood that the invention covers other variations of capacitor designs which may include guard rings, etc.

The capacitor formed by the second and third electrodes 830, 850 are positioned on the oscillating portion of the resonator 810 but could be placed elsewhere. The term “oscillating portion” is intended to mean the portion, region, or member of the resonator that oscillates. For example, the oscillating portion for a QCM typically comprises the piezoelectric material vibrating between the first and second electrodes 820 and 830. For a cantilever type of resonant sensor, the oscillating portion is the cantilever beam and the capacitor is positioned on the beam. For a cMUT type of resonant sensor, the oscillating portion is typically a vibrating membrane and the capacitor is positioned on the membrane. With a thin film bulk acoustic resonant sensor (FBAR), the oscillating portion typically comprises the piezoelectric material and the electrodes positioned to apply a potential difference across the piezoelectric material, etc.

The positioning of the capacitor on the oscillating portion of the resonator 810 enables the sensor 800 to measure the mechanical or electromechanical response to the mass of substances (e.g., analyte of interest and water) that are adsorbed or absorbed in the sensing material 840 and to measure the capacitance change due to the adsorption or absorption of substances in exactly the same sensing material 840 at the same temperature and point in time. The capacitance measurement indicates how much of the response of the resonator 810 (e.g., frequency shift or change in resonance frequency, stiffness or strain) is due to water in the sensing material 840, and thus how much of the response of the resonator 810 is due to an amount of the target analyte adsorbed or absorbed in the sensing material 840. Water has a much higher relative permittivity than the analyte of interest, so that the presence of water in the sensing material 840 greatly changes the capacitance measurement, while the presence of molecules of the target gas often has a negligible effect on the capacitance measurement due to the much lower relative permittivity of the analyte. The capacitance, C, of a parallel plate capacitor is given by equation (1):

C=κϵ₀ A/t (1)

where κ is the relative permittivity, ε₀ is the permittivity of free space, A is the capacitor electrode area, and t is its thickness. As molecules of high relative permittivity adsorb or absorb to the sensing material 840, the capacitance increases.

### Third Example Device

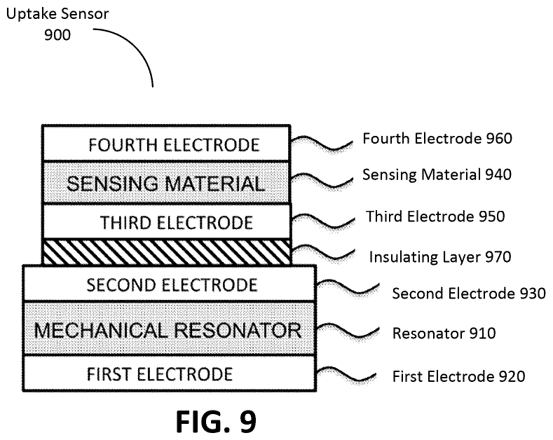

FIG. 9 illustrates a side view of a third example uptake sensor, according to an example embodiment. The uptake sensor 900 (e.g., an uptake sensor 620) includes a first transducer and a second transducer (e.g., transducer 634A, 634B). The first transducer is a resonant sensor, and the second transducer is a parallel plate capacitor.

In this example, relative to the sensor 800 in FIG. 8, the uptake sensor 900 includes four electrodes rather than three electrodes as previously described. As in the previous example, the resonant sensor includes the mechanical resonator 910 and first and second electrodes 920 and 940 coupled to opposite sides of the resonator 910. The first and second electrodes 920 and 940 are positioned to apply a potential difference across the resonator to drive an oscillating motion of the oscillating portion of the resonator 910.

The capacitor is formed by third and fourth electrodes 950 and 960 with the sensing material 940 positioned between the third and fourth electrodes 950 and 960. In this example, the capacitor is preferably positioned on the oscillating portion of the resonator 910 by means of at least one insulating layer 970 that separates the third electrode 950 from the second electrode 9940. Examples of suitable materials for the insulating layer include SiO₂, SiN, Al₂O₃ or AlN. The third and fourth electrodes 950 and 960 preferably comprise substantially parallel layers or plates of metal to form essentially a parallel plate type of capacitor. The fourth electrode 960 should be gas-permeable (e.g. porous, slotted, interdigitated, or serpentine) to ensure that the sensing material 940 is accessible to molecules in a sample or environment to which the sensor is exposed.

### Fourth Example Device

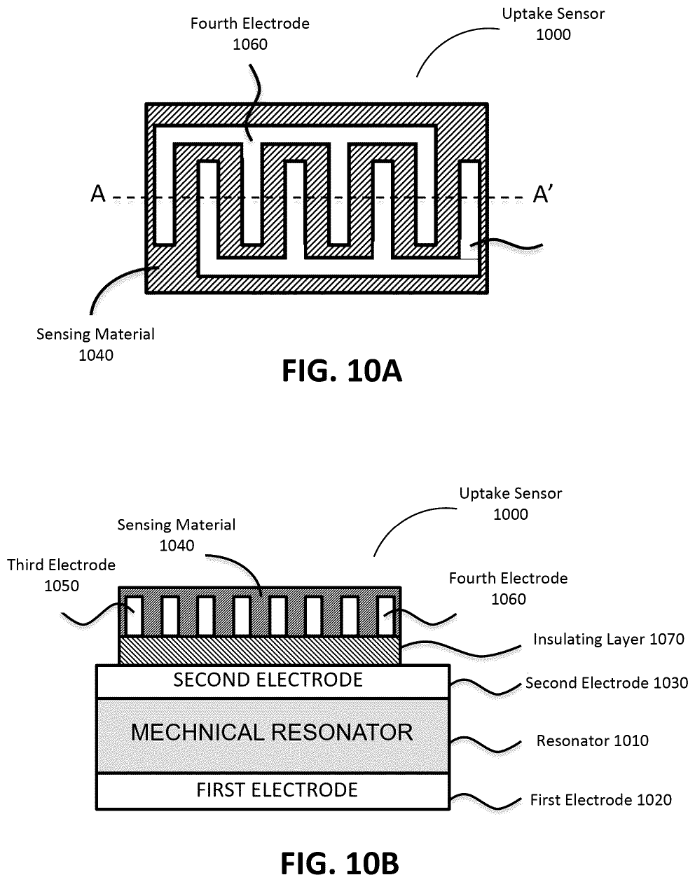

FIGS. 10A and 10B illustrate a fourth example uptake sensor. The uptake sensor 1000 (e.g., an uptake sensor 620) includes a first transducer and a second transducer (e.g., transducer 634A, 634B). The first transducer is a resonant sensor, and the second transducer is an interdigitated capacitor.

FIG. 10A shows a top view of a fourth uptake sensor, according to an example embodiment. As illustrated, a third electrode 1050 and a fourth electrode 1060 form the capacitor. The sensing material 1040 is positioned between the interdigitated electrodes 1050, 1060.

FIG. 10B is a cross-sectional view of the uptake sensor of FIG. 10A along the line A-A′, according to an example embodiment. As illustrated, the device includes four electrodes. The resonant sensor includes the mechanical resonator 1010 and first and second electrodes 1020, 1030 coupled to opposite sides of the resonator 1010, as in previous examples. The first and second electrodes 1020, 1030 are positioned to apply a potential difference across the resonator 1010 to drive an oscillating motion of the resonator. The capacitor is formed by third and fourth electrodes 1050 and 1060. The third and fourth electrodes 1050 and 1060 are interdigitated so that the sensing material 1040 is accessible to both analyte and water molecules in a sample or environment to which the sensor is exposed. The interdigitated capacitor is positioned on the oscillating portion of the resonator 1010 by means of the insulating layer 1070 (e.g., SiO₂, SiN, Al₂O₃ or AlN) that separates the third and fourth electrodes 1050 and 1060 from the second electrode 1030.

### Additional Examples

The devices disclosed above are just examples, and other configurations are also possible.

For instance, configurations of the uptake sensor (e.g., uptake sensor 620) and its corresponding device(s) 630 may include an additional number of transducers (e.g., transducer 634) such as, e.g., 3, 4, 5, 8, or 10 transducers. Similarly, configurations of the uptake sensor (e.g., uptake sensor 620) and its corresponding device(s) (e.g., devices 630) may include an additional number of sensing materials (e.g., sensing material 632) such as, e.g., 3, 4, 5, 8 or 10 sensing materials. Moreover, depending on the configuration, the sensor may have additional electrodes such as 5, 7, 10, or 15 electrodes.

In some configurations, two or more transducers may be coupled to a single sensing material. For example, a single thin film sensing material may be coupled to both a capacitive transducer and a gravimetric transducer (see, e.g., FIGS. 7-10). Similarly, two or more sensing materials may be coupled to a single transducer. For instance, a transducer may be coupled to two different sensing materials 632 (e.g., on a first side and a second side) such that it can measure a characteristics of each sensing material. In still other configurations, a single thin film-sensing material may be coupled to a gravimetric transducer and a second substantially similar thin film of the same material may be coupled to a separate capacitive transducer.

### Reading Transducer Signals

Each uptake sensor (e.g., uptake sensor 620), may be integrated into an electrical readout. Similarly, in some configurations, the uptake sensor 620 may be electrically coupled to one or more readouts (e.g., readouts 652) of the control system (e.g., control system 650), such that the control system can take measurements from the uptake sensor. In various configurations, each transducer (e.g., transducer 634) may have an individual readout, or one or more transducers may have a single readout.

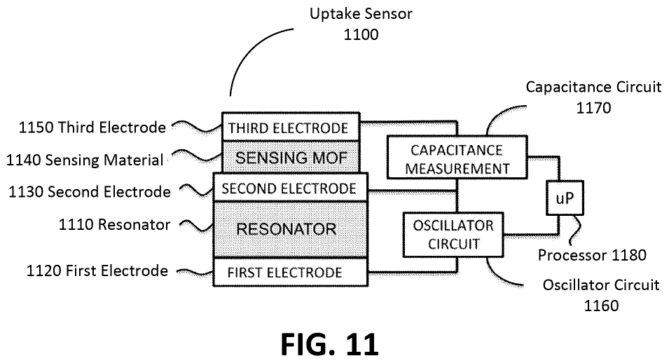

For example, FIG. 11 is a schematic block diagram of a readout electrically coupled to an uptake sensor, according to an example embodiment. The uptake sensor 1100 (e.g., an uptake sensor 620) includes a first transducer and a second transducer (e.g., transducer 634A, 634B). The first transducer is a resonant sensor (e.g., resonator 1110) that measures the uptake mass of an analyte and carrier gas (e.g., a gas mixture) by a sensing material. The second transducer is a capacitor that measures the uptake of materials in the gas mixture (using a sensing material 1140) in a manner that allows the uptake sensor 1100 to decouple a measure of analyte uptake by the sensing material from multiple measurements. In this example, the sensor device has three electrodes 1120, 1130, and 1150 (as described above with reference to FIG. 8).

There are many suitable ways to configure one or more readout circuits to measure both a response of the oscillating portion (e.g., of the resonator 1110) and a capacitance of the capacitor when substances are adsorbed or absorbed in the sensing material 1140. In this example, an oscillator circuit 1160 measures a first response (e.g., mass uptake) of the resonator 1110 (and sensing material) using the first electrode 1120 and the second electrode 1130, and a capacitance measurement circuit 1170 measures a second response (e.g., capacitance) of the sensing material 1140 using the second electrode 1130 and third electrode 1150. A processor 1180 uses the first response and the second response to measure an uptake of a material of interest (e.g., an analyte such as carbon dioxide) by the sensing material 1140.

To continue, the control system (e.g., control system 650) may perform various data processing functions on the various sensors and signals to determine an uptake of a sensing material. To illustrate, FIG. 12 is a schematic block diagram of a data processing flow for measuring uptake of a sensing material using an uptake measurement system, according to an example embodiment.

As illustrated, the data processing flow 1200 includes an oscillator circuit 1210 and a capacitance measurement circuit 1220. The oscillator circuit 1210 outputs a measure of a first characteristic of the sensing material (e.g., frequency, Q, response time, mass uptake, etc.). The capacitance circuit 1220 outputs a measure of a second characteristic of the sensing material (e.g., capacitance, change in capacitance, response time, etc.). The oscillator circuit and the capacitance circuit are communicatively coupled to a processor 1230. The processor 1230 inputs the measure of the first characteristic and the measure of the second characteristic and outputs an uptake of a material (e.g., analyte) by the sensing material (e.g., a thin film).

The processor 1230 is programmed to determine at least one uptake value of the gas by the sensing material in the presence of the environmental gas at the testing conditions. The output may be a number such as a concentration, amount, or mass of the uptake. The analyte and/or humidity values may optionally be displayed to an end-user via the display 1260 in communication with the processor 1230.

In some embodiments, an optional pressure sensor 1240 and an optional temperature sensor 1240 (e.g., thermistor) may be connected to the microprocessor 1230. The pressure sensor 1240 and temperature sensor 1250 measure characteristics of the testing condition (e.g., temperature and pressure) and generate signals representing those characteristics. In configurations including these sensors, the processor 1230 may use the measured characteristics of the testing conditions in the test chamber to determine the uptake of the material by the sensing material.

### III. Example Uptake Measurement

FIG. 13 illustrates a workflow for an uptake measurement of a sensing material, according to an example embodiment. The workflow can include additional or fewer steps and one or more of the steps in the workflow may be repeated or omitted.

In the workflow, an uptake measurement system (e.g., uptake measurement system 100) is configured to measure the uptake of a sensing material (e.g., sensing material 632) using an uptake sensor (e.g., uptake sensor 620). In this example, the uptake measurement system is configured to measure the uptake of a gas in a gas mixture using the sensing material in the uptake sensor.

The devices (e.g., devices 630A and 630B) are fabricated for the uptake sensor. To do so, a powder form of the sensing material is used to form an ink, which is then coated onto one or more transducers (e.g., transducers 634A and 634B) as a thin film. In this example, the uptake sensor includes two devices, a resonator and a capacitor (as described hereinabove). The resonator measures the first characteristics of the sensing material (e.g., mass uptake), and the capacitor measures a second characteristic of the sensing material (e.g., capacitance).

The uptake measurement system generates a testing environment in a test chamber. The testing environment has a set of testing conditions such as, e.g., pressure, temperature, humidity, etc. Testing conditions may also include the gases in the gas mixture and the relative mixture between gases in the gas mixture. As an example, the testing environment may by, e.g., temperature of 25° C., pressure of 1 atm atmosphere, CO₂ at 400 ppm, and relative humidity at 40%, and a carrier gas of synthetic air. The uptake measurement system may wait until the gas is equilibrated to take the measurement.

The uptake measurement system measures a first set of signals representing a first characteristic of the gas in the gas mixture. The first set of signals represents the gas adsorbing or absorbing onto the thin film formed by the material and coupled to the transducer. In the example where the first transducer is a resonator, the signals represent a total mass uptake by the thin film.

The uptake measurement system measures a second set of signals representing a second characteristic of the gas in the gas mixture. The second set of signals represents the gas adsorbing or absorbing onto the thin film formed by the material and coupled to the transducer. In the example where the second transducer is a capacitor, the signals represent a capacitance caused by the uptake of one or more gases in the gas mixture by the thin film.

The uptake measurement system determines the uptake of the gas by the material based on the first set of signals representing the first characteristic, the second set of signals representing the second characteristic, and the set of testing conditions. For instance, using this example, the uptake measurement system determines the uptake of the gas by the material based on the resonator measurements, the capacitor measurements, and the testing conditions including, e.g., humidity and pressure.

### IV. Example Computer System

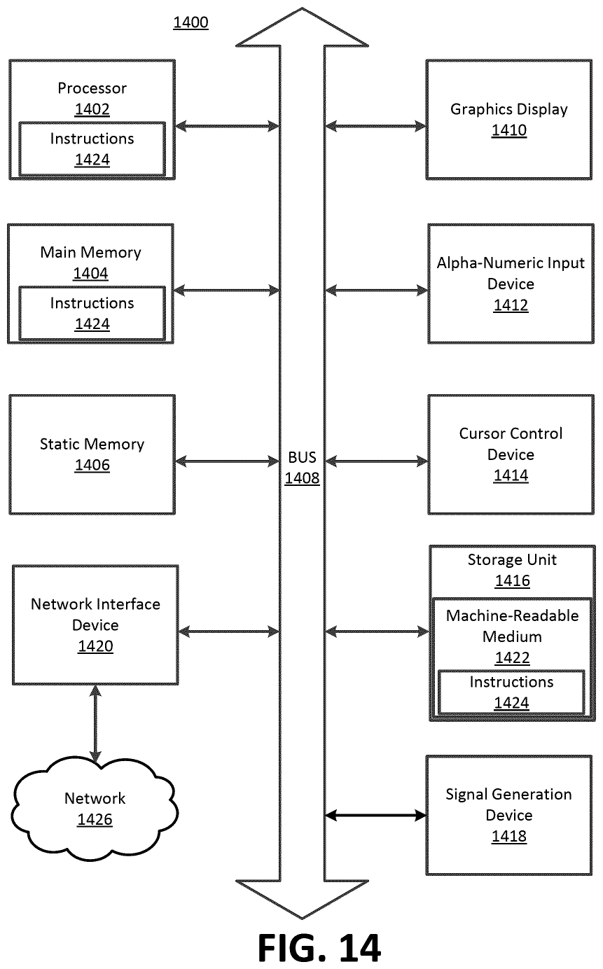

FIG. 14 illustrates an example computer system to enable the various methods and systems described herein. FIG. 14 is a block diagram illustrating components of an example machine for reading and executing instructions from a machine-readable medium. Specifically, various figures above illustrate a diagrammatic representation of a processor or computer system in the example form of a computer system 1400 (e.g., control system 650). The computer system 1400 can be used to execute instructions 1424 (e.g., program code or software) for causing the machine to perform any one or more of the methodologies (or processes) described herein. In alternative embodiments, the machine operates as a standalone device or a connected (e.g., networked) device that connects to other machines.

The machine may be a server computer, a client computer, a personal computer (PC), a tablet PC, a set-top box (STB), a smartphone, an internet of things (IoT) appliance, a network router, switch or bridge, or any machine capable of executing instructions 1424 (sequential or otherwise) that specify actions to be taken by that machine. Further, while only a single machine is illustrated, the term “machine” shall also be taken to include any collection of machines that individually or jointly execute instructions 1424 to perform any one or more of the methodologies discussed herein.

The example computer system 1400 includes one or more processing units (generally processor 1402). The processor 1402 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 1400 also includes a main memory 1404. The computer system may include a storage unit 1416. The processor 1402, memory 1404, and the storage unit 1416 communicate via a bus 1408.

In addition, the computer system 1400 can include a static memory 1406, a graphics display 1410 (e.g., to drive a plasma display panel (PDP), a liquid crystal display (LCD), or a projector). The computer system 1400 may also include alphanumeric input device 1412 (e.g., a keyboard), a cursor control device 1414 (e.g., a mouse, a trackball, a joystick, a motion sensor, or other pointing instrument), a signal generation device 1418 (e.g., a speaker), and a network interface device 1420, which also are configured to communicate via the bus 1408.

The storage unit 1416 includes a machine-readable medium 1422 on which is stored instructions 1424 (e.g., software) embodying any one or more of the methodologies or functions described herein. For example, the instructions 1424 may include the functionalities of modules of the system 130 described in FIG. 1. The instructions 1424 may also reside, completely or at least partially, within the main memory 1404 or within the processor 1402 (e.g., within a processor's cache memory) during execution thereof by the computer system 1400, the main memory 1404 and the processor 1402 also constituting machine-readable media. The instructions 1424 may be transmitted or received over a network 1426 (e.g., network 120) via the network interface device 1420.

While machine-readable medium 1422 is shown in an example embodiment to be a single medium, the term “machine-readable medium” should be taken to include a single medium or multiple media (e.g., a centralized or distributed database, or associated caches and servers) able to store the instructions 1424. The term “machine-readable medium” shall also be taken to include any medium that is capable of storing instructions 1424 for execution by the machine and that cause the machine to perform any one or more of the methodologies disclosed herein. The term “machine-readable medium” includes, but not be limited to, data repositories in the form of solid-state memories, optical media, and magnetic media.

What is claimed is:

1. A method for determining an uptake of a material exposed to a gas in a gas mixture, the method comprising:
generating a testing environment for an uptake sensor within a test chamber of an uptake measurement system, the testing environment comprising a gas mixture under a set of testing conditions, and wherein the uptake measurement system is configured to measure the uptake of a gas in the gas mixture using a first transducer and a second transducer;
measuring, using the first transducer, a first set of signals representing a first characteristic of the gas in the gas mixture adsorbing or absorbing onto a first thin film formed from the material and coupled to the first transducer;
measuring, using the second transducer, a second set of signals representing a second characteristic of the gas in the gas mixture adsorbing or absorbing onto a second thin film formed from the material and coupled to the second transducer; and
determining the uptake of the gas by the material based on the first set of signals representing the first characteristic, the second set of signals representing the second characteristic, and the set of testing conditions.

2. The method of claim 1, wherein the gas mixture comprises carbon dioxide, nitrogen, and water vapor.

3. The method of claim 1, wherein the first transducer is a gravimetric mass transducer and the first set of signals represents a total mass uptake of the material of the first thin film.

4. The method of claim 1, wherein the second transducer is a capacitive transducer and the second set of signals represents a change in capacitance induced at least by adsorption or absorption of a polar component from the gas mixture onto the second thin film.

5. The method of claim 1, further comprising:
calibrating the second transducer by measuring an uptake of an amount of a component of interest in the gas mixture using the first transducer relative to a change in a characteristic induced by the uptake of the component of interest by the second transducer.

6. The method of claim 1, wherein the second transducer is an optical transducer and the second set of signals represents a change in an optical characteristic induced by the gas in the gas mixture adsorbing onto the material of the second thin film.

7. The method of claim 1, wherein the set of testing conditions comprises: a concentration of the gas in the gas mixture, a relative humidity, a constant temperature, a constant pressure, and a constant humidity.

8. The method of claim 1, further comprising:
varying at least one testing condition of the set of testing conditions; and
determining an additional characteristic of the material based on the variation of the at least one testing condition of the set of testing conditions and the variation of the at least one of the first set of signals and the second set of signals.

9. The method of claim 8, wherein the additional characteristic is a diffusivity of the gas in the thin film.

10. The method of claim 1, further comprising:
varying at least one testing condition of the set of testing conditions; and
determining an additional characteristic of the material based on the variation of the at least one testing condition of the set of testing conditions and the variation of at least the first set of signals and the second set of signals.

11. The method of claim 10, wherein the additional characteristic is a diffusivity of the gas in the thin film.

12. The method of claim 1, further comprising:
initializing a plurality of additional sensors within the uptake measurement system, each sensor of the plurality comprising an additional first transducer and an additional second transducer, and each sensor in the testing environment comprising the gas mixture under the set of testing conditions; and
wherein determining the uptake of the gas by the material in the gas mixture is based on the plurality of additional sensors.

13. An uptake measurement system comprising:
a housing;
one or more testing chambers positioned within the housing;
a gas control system configured to generate testing conditions within the one or more testing chambers, the testing conditions comprising a gas in a gas mixture under a set of testing conditions;
a sensor located within a testing chamber of the one or more testing chambers, the sensor comprising:
a first transducer comprising a first thin film formed from a material and coupled to the first transducer, the first transducer configured to generate signals representing a first characteristic of the gas in the gas mixture adsorbing onto the first thin film; and
a second transducer comprising a second thin film formed from the material and coupled to the second transducer, the second transducer configured to generate signals representing a second characteristic of the gas in the gas mixture adsorbing onto the second thin film; and
one or more processors electronically coupled to the gas control system and the sensor;
a non-transitory computer-readable storage medium comprising stored computer program instructions for determining an uptake of the gas in the gas mixture by the material, the computer program instructions, when executed, causing the one or more processors to:
generate, using the gas control system, the set of testing conditions for each of the one or more testing chambers;
measure, using the first transducer, a first set of signals representing a first characteristic of the gas in the gas mixture adsorbing onto the first thin film;
measure, using the second transducer, a second set of signals representing a second characteristic the gas in the gas mixture adsorbing onto the second thin film; and
determine the uptake of the gas by the material based on the first set of signals representing the first characteristic, the second set of signals representing the second characteristic, and the set of testing conditions.

14. The uptake measurement system of claim 13, wherein the gas mixture comprises carbon dioxide, nitrogen, and water vapor.

15. The uptake measurement system of claim 13, wherein the first transducer is a gravimetric mass transducer and the first set of signals represents a total mass uptake of the material of the first thin film.

16. The uptake measurement system of claim 13, wherein the second transducer is a capacitive transducer and the second set of signals represents a change in capacitance induced by adsorption of water from the gas mixture onto the second thin film.

17. The uptake measurement system of claim 13, wherein executing the computer program instructions further causes the one or more processors to:
calibrate the second transducer by measuring an uptake of an amount of water vapor in the gas mixture using the first transducer relative to a change in capacitance induced by the uptake of the amount of water by the second transducer.

18. The uptake measurement system of claim 13, wherein the second transducer is an optical transducer and the second set of signals represents a change in an optical characteristic induced by the gas in the gas mixture adsorbing onto the material of the second thin film.

19. The uptake measurement system of claim 13, wherein the set of testing conditions comprises: a concentration of the gas in the gas mixture, a relative humidity, a constant temperature, a constant pressure, and a constant humidity.

20. The uptake measurement system of claim 13, wherein execution of the computer program instructions further causes the one or more processors to:
vary, using the gas control system, at least one testing condition of the set of testing conditions; and
wherein a determination of an additional characteristic of the material is based on the uptake of the gas in the gas mixture is based on the variation of the at least one testing condition of the set of testing conditions and the variation of the at least one of the first set of signals and the second set of signals.

21. The uptake measurement system of claim 13, wherein execution of the computer program instructions further causes the one or more processors to:
vary at least one testing condition of the set of testing conditions; and
determine an additional characteristic of the material based on the variation of the at least one testing condition of the set of testing conditions and the variation of at least the first set of signals and the second set of signals.

22. The uptake measurement system of claim 13, further comprising:
a plurality of additional sensors, each additional sensor comprising an additional first transducer and an additional second transducer, wherein each additional sensor is located in an additional testing chamber of the one or more testing chambers; and
wherein a determination of the uptake of the gas by the material in the gas mixture is based on the plurality of additional sensors.

23. An uptake measurement system comprising:
a sensor comprising:
a first transducer comprising a first thin film formed from a material and coupled to the first transducer, the first transducer configured to generate signals representing a first characteristic of a gas in a gas mixture adsorbing onto the first thin film when exposed to the gas mixture having a set of testing conditions; and
a second transducer comprising a second thin film formed from a material and coupled to the second transducer, the second transducer configured to generate signals representing a second characteristic of the gas in the gas mixture adsorbing onto the second thin film when exposed to the gas mixture having the set of testing conditions; and
one or more processors;
a non-transitory computer-readable storage medium comprising stored computer program instructions for determining an uptake of the gas by the material, the computer program instructions, when executed, causing the one or more processors to:
measure, using the first transducer, a first set of signals representing the first characteristic of the gas in the gas mixture adsorbing onto the first thin film;
measure, using the second transducer, the second set of signals representing a second characteristic of the gas in the gas mixture adsorbing onto the second thin film; and
determine the uptake of the gas by the material based on the first set of signals representing the first characteristic, the second set of signals representing the second characteristic, and the set of testing conditions.
